(19) United States
(12) Patent Application Publication
(10) Pub. No.: US 2015/0302484 A1
(43) Pub. Date: Oct. 22, 2015

(54) TECHNIQUE FOR EFFECTIVELY PROMOTING GOODS FOR SERVICE THROUGH AN INFORMATION ASSISTANCE SERVICE

(71) Applicant: Grape Technology Group, Inc., Bethlehem, PA (US)

(72) Inventors: Matthew A. Mostad, Kenmore, WA (US); David W. Camarillo, Beaverton, OR (US); Karen L. Johnson, Portland, OR (US)

(21) Appl. No.: 14/582,559

(22) Filed: Dec. 24, 2014

Related U.S. Application Data
(63) Continuation of application No. 10/313,761, filed on Dec. 6, 2002.

(51) Int. Cl. G06Q 30/02

(52) U.S. Cl. CPC G06Q 30/0269

(57) ABSTRACT

A method for providing an information assistance service includes receiving a call from a caller, the call including a request for a suggestion of one or more suppliers of desired goods or service, searching at least one database in response to the request and obtaining search results responsive to the request. The search results including connection data associated with at least one supplier of the desired goods or service, and a promotional offer made by the at least one supplier. A profile associated with the caller is received. The promotional offer is conveyed to the caller via a communication, the format of which is specified in the profile as defined by the caller. The method includes offering to connect the caller to a communication device based on the connection data.

The present application is a continuation application of U.S. patent application Ser. No. 10/313,761, filed on Dec. 6, 2002 which in turn claims the benefit under 35 U.S.C. 119(e) of U.S. Provisional Application No. 60/414,966 filed on Sep. 30, 2002, the entirety of which are incorporated by reference.

### FIELD OF THE INVENTION

The invention relates to a communications system and method, and more particularly to a system and method for offering information assistance including providing promotional information concerning desired goods or service.

### BACKGROUND OF THE INVENTION

It is a common experience to use, e.g., a wireless or wireline telephone, to call an operator for information assistance. In a typical information assistance call, a caller identifies to the operator the name and address (sometimes city or area code) of a party whose telephone number is desired. In response, the operator locates the desired destination number using, e.g., a computer database. The destination number is then provided to the caller, e.g., by a computerized voice server which provides automated voicing of the number, and the caller is afforded an option to be connected to the destination number without the need of first terminating the information assistance call.

The above information assistance has been enhanced to allow a caller to seek information about providers of desired goods or service. For example, a caller who wants to see a particular movie may ask an operator to identify the theaters playing that movie in a given area, or who wants to try a particular cuisine may ask the operator to suggest restaurants specialized in that cuisine in a given area.

Commercials and advertisements are common ways to promote goods or service to consumers. Other well known promotional techniques include a mass distribution of coupons, e.g., in circulars to the public, which entice consumers to purchase particular goods or service at a discounted price.

### SUMMARY OF THE INVENTION

We have recognized that the above-described technique of mass distribution of coupons to the public to promote goods or service is ineffective, stemming from its failure to target those consumers who have a current need for the goods or service. In accordance with the invention, the connection information (e.g., a telephone number) concerning an entity related to selected goods or service (e.g., supplier, manufacturer, etc.) in a database is associated with data concerning a promotion by the entity. In response to a request for a suggestion of one or more entities related to the selected goods or service in an information assistance call, the connection information concerning relevant entities are retrieved, along with the associated promotional data. The promotional data is then communicated to the caller, e.g., via short message service (SMS), facsimile transmission, WAP communications, email (text or voice file), paging, instant messaging, web connection, etc. The method of the communication may be specified in a pre-established profile associated with the caller.

Thus, with the invention, the promotional data concerning particular goods or service, which may include coupon offers, is advantageously targeted to information assistance callers who want to purchase such goods or service. In addition, an entity related to goods or service may access a system connected to the information assistance service, e.g., via a web interface, to input or modify the promotional data in real time.

### BRIEF DESCRIPTION OF THE DRAWINGS

Further objects, features and advantages of the invention will become apparent from the following detailed description taken in conjunction with the accompanying drawing showing an illustrative embodiment of the invention, in which:

FIG. 1 illustrates an information assistance system in accordance with the invention;

FIG. 2 illustrates an arrangement whereby an entity related to service or goods (e.g., supplier, manufacturer, etc.) may communicate special offer information with a server, made part of the system of FIG. 1;

FIG. 3 is a flow chart depicting a routine for assisting a user with information concerning suppliers of desired goods or service and any special offers made thereby, in accordance with the invention;

FIG. 4 illustrates a user profile gateway in the information assistance system connected to a profile manager managing user profiles; and

FIG. 5 illustrates an alternative information assistance system.

### DETAILED DESCRIPTION

The invention is directed to promoting goods or service by communicating special offers or information thereof to a user of an information assistance service. A well known technique for promoting goods or service is a mass distribution of coupons, e.g., in circulars to the public which entice consumers to purchase the promoted goods or service at a discounted price. However, this prior art technique is ineffective, stemming from its failure to target those consumers who have a current need for the goods or service.

In accordance with the invention, special offers of goods or service are communicated to a user of an information assistance service who seeks information concerning entities related to such goods or service, e.g., the suppliers of such goods or service. The information assistance service may be accessed by a user using a wireline telephone, wireless telephone, personal digital assistant (PDA) or other communications device. An operator who attends to such an information assistance service may transmit to the user a special offer (e.g., an electronic coupon) which relates to the content of the information assistance, via a short message service (SMS), facsimile, wireless application protocol (WAP), email, paging, instant messaging, web connection or other communications. The term “operator” used herein broadly encompasses entities that are capable of providing information assistance in a communication environment, including without limitation human operators, voice response/recognition capabilities, web- or WAP-enabled operator services, and other electronic access. In accordance with an aspect of the invention, the goods or service suppliers may initiate or update their special offers in real time, e.g., via web interface with a server connected to the information assistance service.

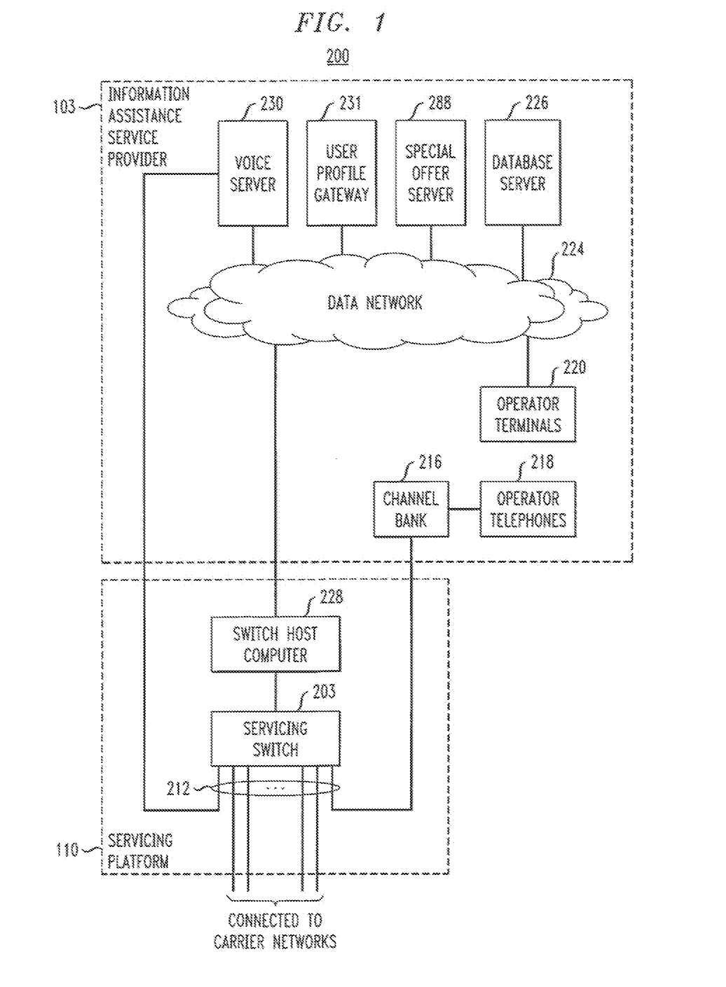

FIG. 1 illustrates information assistance system 200 embodying the principles of the invention. In this illustrative embodiment, users of a particular telephone carrier may dial, speak or otherwise communicate predetermined access digits, access codes or retail numbers, or input a predetermined address or URL established by the carrier to access information assistance service provider 103. For example, the predetermined access digits may be “411,” “*555,” “555-1212,” “00,” etc. On learning one such access digit sequence initiated from a user's communications device, a switching system of the user's telephone carrier in a conventional manner routes the information assistance call to provider 103 through servicing platform 110.

It should be noted that even though both provider 103 and servicing platform 110 appear in the same figure, they may or may not be located in the same geographic area. In FIG. 1, servicing platform 110 comprises servicing switch 203 having T1 spans 212 for connection to voice server 230, channel bank 216, and carrier networks including, e.g., carrier network 113. Switch 203 may receive an incoming information assistance call from one of the carrier networks through a carrier switch therein. It may also be used to place an outgoing call through one of the carrier networks which may be different than that used for the incoming call.

Channel bank 216 in provider 103 is used to couple multiple operator telephones 218 to switch 203. The operators in system 200 are further equipped with operator terminals 220, each of which includes a video display unit and a keyboard with associated dialing pad. Operator terminals 220 are connected over data network 224 to one or more database server(s) 226 (although only one is shown here). Switch host computer 228, voice server 230 and user profile gateway 231 are also connected to data network 224. By way of example, data network 224 includes a local area network (LAN) supplemented by a number of point-to-point data links. Through data network 224 and routers (not shown) components of system 200, may also be connected to the Internet.

Switch 203 is conventional and supports digital 1 connectivity. The operation of switch 203 is governed by instructions stored in switch host computer 228. In this illustrative embodiment, switch 203 includes, inter alia, arrays of digital signal processors (DSPs). These DSPs can be programmed and reprogrammed to function as, among other things, call progress analyzers (CPAs), call progress generators (CPGs), multi-frequency (MF) tone generators/detectors, dual-tone multi-frequency (DTMF) generators/detectors, or conference units, depending on the demand placed on system 200 and switch 203 for each corresponding function.

An incoming information assistance call from a user is received by switch 203 in system 200 which connects it to an available operator's telephone. If no operator is available when a call is received, the call is queued in a conventional manner until an operator becomes available. In this instance, automatic call distribution (ACD) logic of conventional design (not shown) is used to queue and distribute calls to operators in the order in which they are received, and such that the call traffic is distributed evenly among the operators. The ACD logic may reside in host computer 228 or elsewhere in system 200. In other instances, other distribution logic schemes may be utilized, such as skills-based routing or a priority scheme for preferred users.

Operators may utilize database server 226 to provide information assistance including searching for a user's desired party and determining the appropriate destination telephone number of the party. Other information assistance concerning restaurant recommendations, movie listings, events, special offers, etc. may also be provided by searching database server 226. In particular, the special offer information may be obtained through server 226 in cooperation with special offer server 288 described below with which suppliers of goods or service may communicate in real time to initiate or update special offers for purchase of their goods or service.

Voice server 230 is used to play the constant repeated parts of an operator's speech, namely, the various greetings and signoffs (or closings). Voice server 230 is connected via data network 224 to switch host computer 228 and via one or more T1 spans to switch 203. Voice server 230 may comprise a general purpose computer and one or more voice cards for voice recognition, voice recording and playback, and call progress analysis. At appropriate stages in a call progression, switch host computer 228 initiates a voice path connection between voice server 230 and switch 203 such that the user, or the user and the operator, are able to hear whatever pre-recorded speech is played on that connection by voice server 230. Computer 228 then instructs voice server 230, via data network 224, what type of message to play, and passes data parameters that enable voice server 230 to locate the message appropriate to the call state.

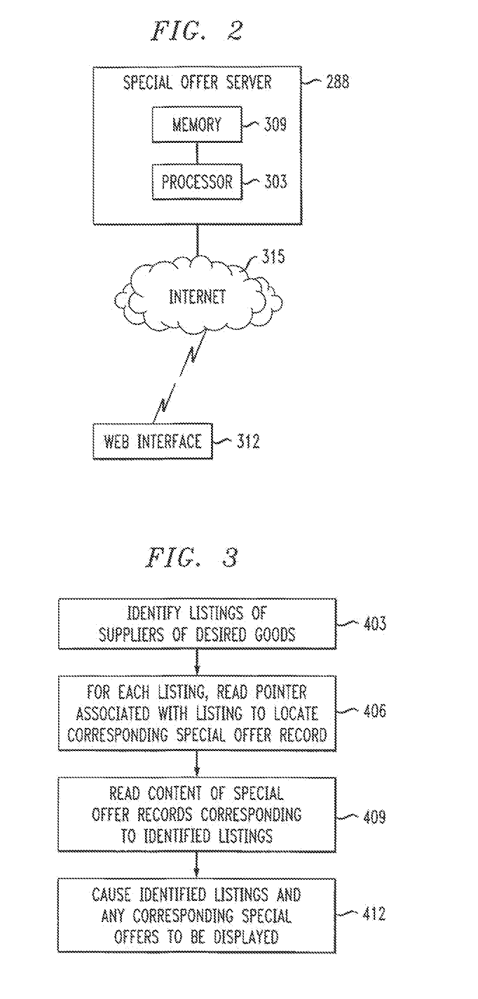

By way of example, the user in the instant information assistance call seeks information about suppliers of pet food, The operator who answers the call may elicit from the user the type of the desired pet food (e.g., dog food), and the desired area where the supplier is located. The operator then uses, e.g., database server 226, to search for listings of relevant pet food suppliers. In accordance with the invention, some of these listings may be associated with special offers made by the corresponding pet food suppliers for purchase of their goods (e.g., dog food) or service (e. pet grooming). In conducting the search, server 226 communicates with special offer server 288 and to check for any special offers. To that end, server 288, illustrated in FIG. 2, includes memory 309 which contains special offer records associated with the listings in database server 226. In this illustrative embodiment, each listing is associated with a pointer, containing a memory address, for locating the corresponding special offer record in memory 309. Alternatively, the listing may be associated with an identification (ID) of the corresponding special offer record for its retrieval from memory 309.

The special offer records contain sale, discount or other promotional information provided by entities related to goods or service, e.g., suppliers of goods or service in this particular illustrative embodiment. Each supplier participating in the subject promotional service may have access to the special offer record assigned to the supplier. In this instance, each participating supplier may log on to server 288 connected to Internet 315 at a predetermined URL. For example, through web interface 312, the participating supplier when logging on enters on a home web page a vendorID previously assigned thereto and a password previously selected by the participating supplier. After receiving the vendorID and password, processor 303 in a well known manner verifies the received password to ensure that the supplier is a legitimate participant. After the password verification, processor 303 retrieves from memory 309 the special offer record assigned to the participating supplier, which is identified by the received vendorID. Through web interface 312, the supplier may input data to, or edit the content of, the assigned special offer record to initiate or update any special offer or promotion of its goods or service in real time. In this instance, one of the participating pet food suppliers, e.g., Petco, has in its special offer record data concerning an electronic coupon “$5 off any purchase of $20 or more,” and a coupon code for redeeming the coupon at the store.

Continuing with the above example where an information assistance caller requests a suggestion of suppliers of desired goods, e.g., dog food, in a given area, database server 226 identifies, in a search, listings of suppliers of the desired goods meeting such a request, as indicated at step 403 in FIG. 3. For each listing, server 226 at step 406 reads the aforementioned pointer associated with the listing to locate the corresponding special offer record stored in memory 309 of server 288. Server 226 at step 409 reads from memory 309 the content of the special offer records corresponding to the identified listings. At step 412 server 226 causes the identified listings and any corresponding special offers described in the records to be displayed on operator terminal 220. In this example, one of the identified listings is Petco's which is displayed alongside its offer of “$5 off any purchase of $20 or more.” The operator reads from terminal 220 the displayed listings and any corresponding special offers to the caller one by one in the order of their display. The order of the displayed listings may be predetermined, e.g., an alphabetical order. The order may alternatively be random, or it may be subscription based, e.g., the priority of listing a business over others depending on an amount of the fee paid by the business to the information assistance service, in accordance with a fee schedule.

In this example, upon learning from the operator the identified listings and any corresponding special offers, the caller is particularly interested in the listing of Petco because of its attractive offer. Accordingly, the caller expresses to the operator his/her interest in the Petco listing. In response, the operator in a conventional manner offers to connect the caller to the telephone number appearing in the Petco listing, without the need of first terminating the call. At the same time, the operator offers to transmit Petco's special offer to the user, in accordance with the invention.

Another scenario where an information assistance request leads to a transmission of a special offer to the caller may begin with a typical inquiry such as “Where is the nearest car radiator repair shop?” This inquiry may be accompanied by information concerning the caller's current location. Such location information may be provided by the caller informing the operator of his/her current address, or identifying the closest street or landmark. Alternatively, such location information may be automatically provided to the operator by conventional means such as a global positioning system (GPS) device in the caller's telephone transmitting GPS information (defining the caller's telephone location) through the information assistance call connection, or a well known triangulation technique based on the knowledge of the locations of the base stations through which the call is connected to information assistance service provider 103.

In any event, with the caller location information, the operator is able to search database server 226 for listings of repair shops as requested. In this instance, the uncovered listings may be displayed in the order of the distance of the listed repair shop from the caller's current location, with the closest shop listed first. In a manner described before, any special offer associated with a listed repair shop would also be uncovered, and displayed alongside its listing. The operator reads the displayed listings and any corresponding special offers to the caller one by one in the order of their display. For example, the caller in this instance may express to the operator his/her interest in one of the listings, say, ABC Mechanics', with a special offer. In a conventional manner, the operator may communicate to the caller the address of, and/or directions to, ABC Mechanics when requested, and offer to connect the caller to ABC Mechanics. The operator then offers to transmit ABC Mechanics' special offer to the user, in accordance with the invention.

The caller may specify the method of transmission of the special offer to him/her in the information assistance call. For example, the specified method may be via facsimile, in which case the caller communicates a preferred facsimile number to the operator. Accordingly, the operator causes server 288 to send the electronic coupon code, along with the related information, to the caller's facsimile number through a facsimile facility (not shown).

Another specified method of transmission may be via SMS, in which case the user may inform the operator that the caller's communication device being used for the call has an SMS capability. Accordingly, the operator causes server 288 to obtain an automatic number identification (ANI) described below indicating the telephone number of the communication device, to which server 288 sends an SMS message, including the electronic coupon code and related information (e.g., the coupon expiration date), via an SMS center (not shown). As is well known, an SMS is a store and forward service where short messages are not sent directly from a sender to a recipient but rather via an SMS center. A conventional mobile telephone network that supports SMS has one or more SMS centers to handle and manage the short messages. The aforementioned special offer SMS message is destined for the caller's communication device identified by the AM in the SMS message.

Yet another specified method of transmission of the special offer may be via a WAP (wireless application protocol) site, in which case the user may inform the operator that the caller's communication device being used for the call is capable of reading WAP content. As is well known, to enable mobile devices to effectively access the Internet through the wireless network, which is not an ideal network for such access as it typically affords low bandwidth, high latency and unreliable connections, a WAP standard for the mobile devices has been developed to overcome the particular constraints of the wireless environment.

For example, similar to the Internet standards, WAR specifies use of a wireless markup language (WML), which is a subset of an extensible markup language (XML), for writing WAP content. WML is designed to make optimum use of a small display which is typical of a mobile device. The resulting WAP content is scalable, e.g., from a two-line text display to a full graphic screen of a larger display. The WAP content can be read by a user using WAP microbrowser software installed in the mobile device. The communications between the mobile device and the Internet is through a WAP gateway, which serves as an interface between a wireless network and the Internet.

The WAP gateway provides the necessary protocol translation (e.g., between WAP and transmission control protocol/Internet protocol (TCP/IP)) and optimization, security, activity tracking and administration. Messages communicated between a mobile device and the WAP gateway are in accordance with a WAP datagram protocol (WDP). For example, when a request from the mobile device which comprises a URL is sent via a wireless network to the WAP gateway, the request includes a device ID identifying the mobile device. In response, a hypertext transfer protocol (HTTP) interface in the gateway retrieves the requested content from the WAP site on the Internet at the URL. The retrieved content is converted into a compressed data format for transmission over the wireless network to the mobile device identified by its device ID. The WAP microbrowser software in the mobile device interprets the compressed data and displays the interactive WAP content.

Accordingly, the operator in this instance may inform the information assistance caller of the URL of the WAP site for accessing the aforementioned electronic coupon information in Petco's special offer record, expressed in WML.

Similarly, the electronic coupon information may be expressed e.g., in HTML or XML, and placed on a secure website for the caller to access anytime using a device running the necessary web browser software. The particular URL of the website may be designated to the caller exclusively for his/her personal consumption. Of course, the electronic coupon information may also be conveyed to the caller via other communications means such as email, paging, instant messaging, etc.

In a second embodiment, the method of transmission of a special offer to the caller is specified in a user profile associated with the caller. A user profile may contain personal preferences, including those preferences relating to use of enhanced assistance service features, methods of transmission of special offers, etc. For example, these personal preferences may be specified by a user during a telephone service registration with a carrier. They may be established by the user in response to such direct registration questions as “How do you want a special offer to be transmitted to you from an information assistance service?” The answers to such direct questions may make up the personal preferences.

A user profile is identified by the user's telephone number and managed by a profile manager described below. Referring back to FIG. 1, an information assistance call is received by servicing switch 203 in information assistance system 200. In a well known manner, switch 203 derives, from the call set-up signals associated with the call, an ANI indicating the telephone number of the communication device from which the call originates. Host computer 228 then requests any user profile identified by such an ANI from gateway 231 connected to data network 224.

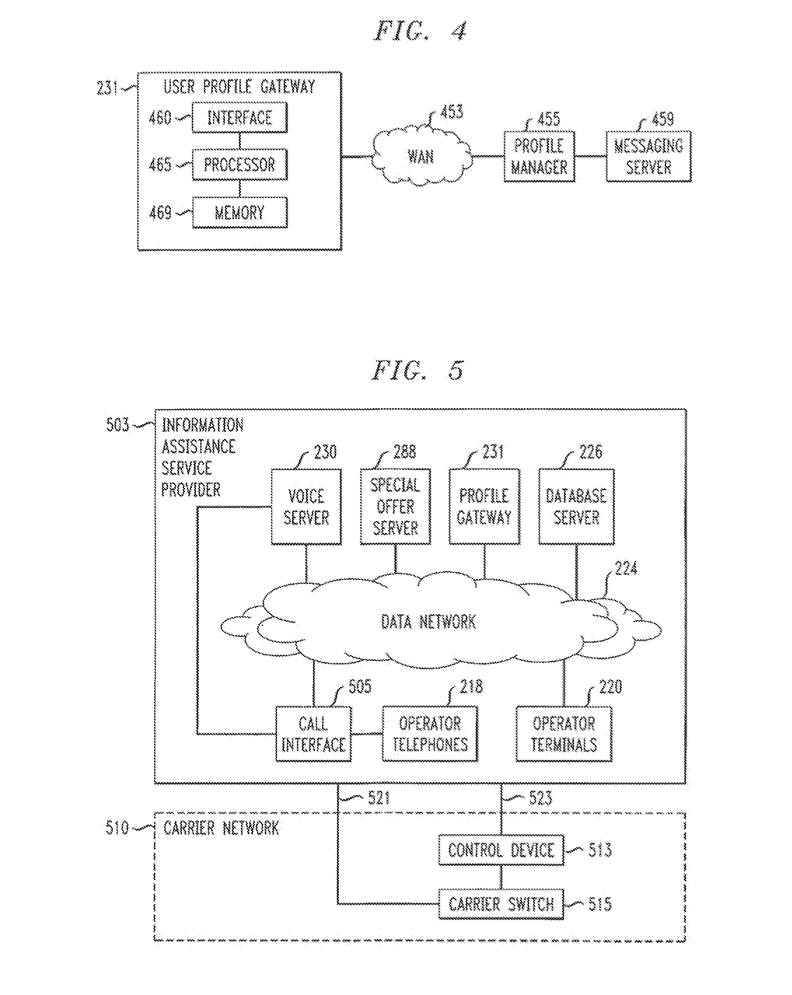

Referring also to FIG. 4, gateway 231 receives the profile request including the ANI from data network 224 through interface 460. In response to such a request, processor 465 searches memory 469 for the profile identified by the ANI It should be noted at this point that all profile data is input and updated through profile manager 455. Copies of the profile data are distributed by manager 455 to the profile gateways in various information assistance systems through wide area network (WAN) 453. In this illustrative embodiment, a master copy of the profiles is kept at manager 455. For example, profile gateway 231 initially forwards requests for new profiles to manager 455, and caches copies of the requested profiles from manager 455 in local memory 469 for rapid, subsequent retrieval of the profiles. Memory 469 here generically includes disks, caches, and volatile and nonvolatile memories. When a particular profile in gateway 231 is updated at manager 455, the latter notifies gateway 231 that the particular profile is expired.

If processor 465 determines that the requested profile cannot be found in memory 469 or the requested profile is expired, processor 465 forwards the profile request to manager 455 through interface 460. In response, manager 455 provides to gateway 231 any latest profile identified by the ANI. Otherwise, processor 465 retrieves from memory 469 any available, unexpired profile identified by the ANI.

Thus, in the second embodiment, the user profile identified by the ANI of the instant information assistance call by the caller may specify one or more methods of transmission of a special offer to the caller. These methods may be prioritized in accordance with the caller's preferences. A first method of transmission may be via facsimile, in which case the facsimile number is provided beforehand by the caller in the callers profile. In response to a request by the operator for transmission of the special off to the user, database server 226 sends to profile gateway 321 the special offer information to be delivered (electronic coupon code and related information in this case). Gateway 321 generates a message containing the special offer information, and data concerning delivery methods ranked in the order of the caller's preferences, as specified in the caller's profile. This message is sent to profile manager 455, which in response generates an appropriate request to messaging server 459 for delivery of the special offer information.

In this instance, messaging server 459 may be situated at the same location as profile manager 455. Server 459 serves as a gateway for delivering electronic content information to a user, e.g., via facsimile, SMS, WAP, email, paging, etc. When it is determined that the special offer information needs to be delivered via one of these communications, profile manager 455 forwards the necessary content and addressing information (e.g., facsimile number, ANI for SMS, URL of a WAP site, email address, pager number, etc.) to messaging server 459. Messaging server 459 attempts a delivery of the special offer information via the appropriate method of transmission, and feeds back to profile manager 455 information about the delivery status. For example, in the event that a first preferred delivery method is not successful, server 459 informs manager 455 of the unsuccessful delivery status. In response, manager 455 may cause server 459 to attempt the delivery via a second preferred delivery method, and so on and so forth.

The foregoing merely illustrates the principles of the invention. It will thus be appreciated that those skilled in the art will be able to devise numerous other arrangements which embody the principles of the invention and are thus within its spirit and scope.

For example, in the illustrative embodiment, profile gateway 231 needs to communicate in real time with profile manager 455 each time when a requested profile is unavailable or expired in memory 469. In an alternative embodiment, to avoid such real time communications with manager 455, thereby saving the response time, a copy of each profile in profile manager 455 is also stored in the profile gateways in all of the information assistance systems, including profile gateway 231. Whenever a change is made to a profile in manager 455, the latter immediately communicates the change to each profile gateway to ensure that each gateway has the current set of profiles, identical to the master set in manager 455. Nonetheless, this “copy-all” approach is disadvantageous in that it requires more local memory capacity to store a larger profile database in each gateway.

In addition, the invention equally applies regardless of whether feature group D (FGD) type signaling, SS7 out-of-band signaling or other signaling is used for communications between carrier switches and switch 203 of FIG. 1.

Further, information assistance system 200 may be configured differently from the configuration of FIG. 1. FIG. 5 illustrates an alternative information assistance system configuration. As shown in FIG. 5, the alternative system has call interface 505 in information assistance service provider, which is no longer connected to servicing platform 110. The functionality of platform 110 principally is carried out in carrier network 510 in the alternative system. In fact, control device 513 in network 510 performs similar functions to switch host computer 228, and carrier switch 515 performs not only its conventional carrier switching functions, but also those of servicing switch 203 described before, under control of device 513. In this alternative system, an information assistance call is recognized by control device 513 when it is routed through carrier switch 515. Device 513 causes the information assistance call to be connected through one of pre-designated direct inward dial (DID) connections 521 to provider 503, which is received by call interface 505 therein. Interface 505, connected to operator telephones 218, includes the aforementioned ACD logic for distributing the call to an operator at one of telephones 218 in a conventional manner. In the event that the information assistance call needs to be connected to a desired destination number, the operator causes the destination number and a “call completion” command to be transmitted to control device 513 via Internet connection 523. In response, control device 513 instructs switch 515 to connect the instant information assistance call to the received destination number. As per the instructions, switch 515 completes the call to the destination number.

Finally, information assistance system 200 is disclosed herein in a form in which various functions are performed by discrete functional blocks. However, any one or more of these functions could equally well be embodied in an arrangement in which the functions of any one or more of those blocks or indeed, all of the functions thereof, are realized, for example, by one or more appropriately programmed processors.

What is claimed is:

1. A method for providing an information assistance service, comprising:
receiving a call from a caller, the call including a request for a suggestion of one or more suppliers of desired goods or service;
searching at least one database in response to the request;
obtaining search results responsive to the request, the search results including connection data associated with at least one supplier of the desired goods or service, and a promotional offer made by the at least one supplier;
retrieving a profile associated with said caller;
conveying the promotional offer to the caller via a communication, the format of which is specified in said profile as defined by said caller; and
offering to connect the caller to a communication device based on the connection data.

2. The method of claim 1 wherein the communication device includes a telephone.

3. The method of claim 2 wherein the connection information includes a telephone number.

4. The method of claim 1 wherein the promotional offer includes a coupon offer.

5. The method of claim 1 wherein the communication includes an SMS.

6. The method of claim 5 wherein a destination address of the communication is identified by an ANI of a second communication device from which the call originates.

7. The method of claim 1 wherein the communication includes a facsimile transmission.

8. The method of claim 1 wherein the communication includes a communication pursuant to a WAP.

9. The method of claim 1 wherein the communication includes an email.

10. The method of claim 1 wherein the communication includes paging.

11. The method of claim 1 wherein the communication includes instant messaging.

12. The method of claim 1 wherein the communication includes a web connection.

13. The method of claim 1 wherein the profile is identifiable by an ANI of a second communication device from which the call originates.

14. The method as claimed in claim 1, wherein said profile includes multiple manners for conveying promotions, each of which being defined by said caller.

15. The method as claimed in claim 14, wherein said multiple manners for conveying promotions, stored in said profile, are prioritized in accordance with preferences of said caller.
